(19) United States
(12) Patent Application Publication
(10) Pub. No.: US 2026/0065426 A1
(43) Pub. Date: Mar. 5, 2026

(54) FRAME EXPOSURE ENHANCEMENT BASED ON LOCAL TONE CURVE RESAMPLING

(71) Applicant: APPLE INC., Cupertino, CA (US)

(72) Inventors: Muge WANG, San Jose, CA (US); Wei SUN, San Jose, CA (US); Xuemei ZHANG, Mountain View, CA (US); Henryk K. BLASINSKI, Mountain View, CA (US)

(73) Assignee: APPLE INC., Cupertino, CA (US)

(21) Appl. No.: 18/825,941

(22) Filed: Sep. 5, 2024

(51) Int. Cl. G06T 5/50; G06T 3/40; G06T 5/40; H04N 23/71; H04N 23/73

(52) U.S. Cl. CPC G06T 5/50; G06T 3/40; G06T 5/40; G06T 2207/10016; G06T 2207/10144; H04N 23/71; H04N 23/73

(57) ABSTRACT

Disclosed herein are a system, method, and computer program product embodiments for generating an exposure-adjusted frame based on local tone curve sampling. In some embodiments, a change in exposure times between a first frame captured by an image sensor and a second frame captured by an image sensor subsequent to the first frame may be determined. Different local tone curve resampling techniques may be performed based on whether the change is an increase or decrease in exposure times. Such techniques may resample local tone curves generated for the first frame to match the exposure time of the second frame. The resampled local tone curves, when applied to the second frame, mitigate various artifacts in the second frame, such as frame-to-frame flicker.

### BACKGROUND

Tone mapping is the process of remapping pixel intensity values (e.g., brightness levels) for portions of a given input image to different levels in the corresponding portions of a “tone mapped” output image. Tone mapping may, e.g., alter the pixel intensity values of different portions of the image to adapt the image to how the scene would be perceived by the human eye. In general, there are two approaches to tone mapping: global tone mapping and local tone mapping. Global tone mapping refers to utilizing a single tone curve that maps input pixel intensity values to output pixel intensity values. Local tone mapping refers to applying a tone curve to a portion of an image. In practice, tone mapping may be used to compress the dynamic range of an input (e.g., captured) image to fit into the dynamic range of an output device with the goal of not losing spatial and color details. This usually involves darkening the input image's bright regions and brightening the input image's darker regions while keeping local spatial contrast intact.

Tone mapping algorithms can use a variety of image statistics to estimate how image brightness should be changed. However, even small changes in the framing of the input image (e.g., when the camera is panning, when an object being captured is moving (e.g., internal scene motion)) can have a large impact on the image statistics, and as a result, on the local tone mapping curves that should be applied to a given portion of the image. Consequently, the same object in a scene may be tone mapped in different ways in consecutively captured frames, thereby causing the same object to have a drastically changed appearance in the consecutively captured frames. This can lead to the generation of visible artifacts (e.g., flicker in a video, banding when image frames are stitched together to generate a panorama, poor contrast, saturation, and the like).

### SUMMARY

Various embodiments for generating an exposure-adjusted frame based on local tone curve sampling are disclosed. In some embodiments, a method includes determining a change between a first exposure time of a first frame captured by an image sensor and a second exposure time of a second frame captured by the image sensor subsequent to the first frame. The method also includes sampling a local tone curve generated for the first frame based on the change. The method further includes applying the sampled local tone curve to the second frame to generate an exposure-adjusted second frame. The method also includes displaying the exposure-adjusted second frame.

In some embodiments, a system includes a memory and at least one processor. The at least one processor is configured to determine a change between a first exposure time of a first frame captured by an image sensor and a second exposure time of a second frame captured by the image sensor subsequent to the first frame. The at least one processor is also configured to sample a local tone curve generated for the first frame based on the change. The at least one processor is further configured to apply the sampled local tone curve to the second frame to generate an exposure-adjusted second frame. The at least one processor is also configured to display the exposure-adjusted second frame.

In some embodiments, a non-transitory computer readable medium having instructions stored thereon that, when executed by at least one processor, cause the at least one processor to perform operations. The operations include determining a change between a first exposure time of a first frame captured by an image sensor and a second exposure time of a second frame captured by the image sensor subsequent to the first frame. The operations also include sampling a local tone curve generated for the first frame based on the change. The operations further include applying the sampled local tone curve to the second frame to generate an exposure-adjusted second frame. The operations also include displaying the exposure-adjusted second frame.

### BRIEF DESCRIPTION OF THE DRAWINGS

The accompanying drawings are incorporated herein and form a part of the specification.

FIG. 1 is a diagram of an electronic device, according to some embodiments.

FIG. 2 is a block diagram illustrating components in an electronic device, according to some embodiments.

FIG. 3 is a block diagram illustrating image processing pipelines implemented using an image signal processor, according to some embodiments.

FIG. 4 is a block diagram of a local tone curve resampler, according to some embodiments.

FIG. 5 is a diagram illustrating the resampling of a local tone curve for a particular region of a frame based on the exposure time increasing frame to frame, according to some embodiments.

FIG. 6 is a diagram illustrating the resampling of a local tone curve for a particular region of a frame based on the exposure time decreasing frame to frame, according to some embodiments.

FIG. 7 is a flowchart of a method for generating an exposure-adjusted frame, according to some embodiments.

FIG. 8 is a flowchart of a method for sampling a local tone curve generated for a first frame based on a determination that the exposure time of a second frame is longer than the exposure time of the first frame, according to some embodiments.

FIG. 9 is a flowchart of a method for sampling a local tone curve generated for a first frame based on a determination that the exposure time of a second frame is shorter than the exposure time of the first frame, according to some embodiments.

FIG. 10 is an example computer system that can be used for implementing some aspects or portion(s) thereof.

In the drawings, like reference numbers generally indicate identical or similar elements. Additionally, generally, the left-most digit(s) of a reference number identifies the drawing in which the reference number first appears.

### DETAILED DESCRIPTION

Provided herein are a system, apparatus, device, method and/or computer program product embodiments, and/or combinations and sub-combinations thereof, for generating an exposure-adjusted frame based on local tone curve sampling. In some embodiments, a change in exposure times between a first frame captured by an image sensor and a second frame captured by an image sensor subsequent to the first frame may be determined. Different local tone curve resampling techniques may be performed based on whether the change is an increase or decrease in exposure times. Such techniques may resample local tone curves generated for the first frame to match the exposure time of the second frame. The resampled local tone curves, when applied to the second frame, mitigate various artifacts in the second frame, such as frame-to-frame flicker.

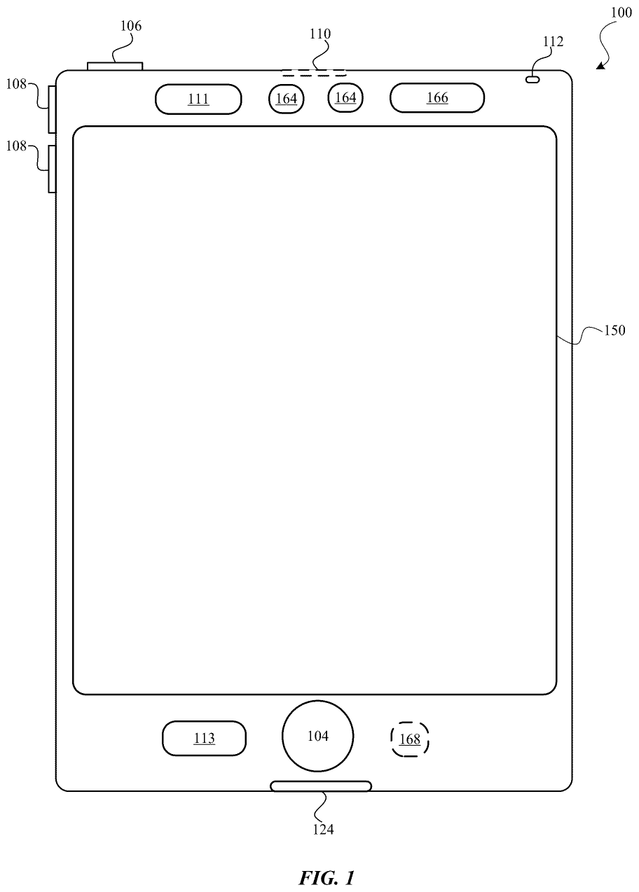

Embodiments of electronic devices, user interfaces for such devices, and associated processes for using such devices are described herein. In some embodiments, the device is a portable communications device, such as a mobile telephone, that also includes other functions, such as personal digital assistant (PDA) and/or music player functions. Exemplary embodiments of portable multifunction devices include, without limitation, the iPhone®, iPod Touch®, Apple Watch®, and iPad® devices from Apple Inc. of Cupertino, California. Other portable electronic devices, such as wearables, virtual, augmented, or mixed reality headsets, laptops or tablet computers, are optionally used. An exemplary embodiment of a headset includes the Apple Vision Pro® from Apple Inc. In some embodiments, the device is not a portable communication device, but is a desktop computer or other computing device that is not designed for portable use. In some embodiments, the disclosed electronic device may include a touch-sensitive surface (e.g., a touch screen display and/or a touchpad). An example electronic device described below in conjunction with FIG. 1 (e.g., device 100) may include a touch-sensitive surface for receiving user input. The electronic device may also include one or more other physical user-interface devices, such as a physical keyboard, a mouse and/or a joystick.

FIG. 1 is a diagram of an electronic device 100, according to some embodiments. Device 100 may include one or more physical buttons, such as a “home” or menu button 104. Menu button 104 is, for example, used to navigate to any application in a set of applications that are executed on device 100. In some embodiments, menu button 104 includes a fingerprint sensor that identifies a fingerprint on menu button 104. The fingerprint sensor may be used to determine whether a finger on menu button 104 has a fingerprint that matches a fingerprint stored for unlocking device 100. Alternatively, in some embodiments, menu button 104 is implemented as a soft key in a graphical user interface (GUI) displayed on a touch screen.

In some embodiments, device 100 includes touch screen 150, menu button 104, push button 106 for powering the device on/off and locking the device, volume adjustment buttons 108, Subscriber Identity Module (SIM) card slot 110, head set jack 112, and docking/charging external port 124. Push button 106 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 includes various components including a memory (which may include one or more computer readable storage mediums), a memory controller, one or more central processing units (CPUs), a peripherals interface, an RF circuitry, an audio circuitry, speaker 111, microphone 113, input/output (I/O) subsystem, and other input or control devices. Device 100 may include one or more image sensors 164, one or more proximity sensors 166, and one or more accelerometers 168. Device 100 may include more than one type of image sensor 164. Each type may include more than one image sensor 164. For example, one type of image sensor 164 may be a camera and another type of image sensor 164 may be infrared sensor that may be used for face recognition. Additionally or alternatively, image sensors 164 may be associated with different lens configuration. For example, device 100 may include rear image sensors, one with a wide-angle lens and another with as a telephoto lens. Device 100 may include components not shown in FIG. 1, such as an ambient light sensor, a dot projector, and a flood illuminator.

Device 100 is only one example of an electronic device, and device 100 may have more or fewer components than listed above, some of which may be combined into a component or have a different configuration or arrangement. The various components of device 100 listed above are embodied in hardware, software, firmware, or a combination thereof, including one or more signal processing and/or application specific integrated circuits (ASICs). While the components in FIG. 1 are shown as generally located on the same side as the touch screen 150, one or more components may also be located on an opposite side of device 100. For example, the front side of device 100 may include an infrared image sensor 164 for face recognition and another image sensor 164 as the front camera of device 100. The back side of device 100 may also include additional image sensors 164 as the rear cameras of device 100.

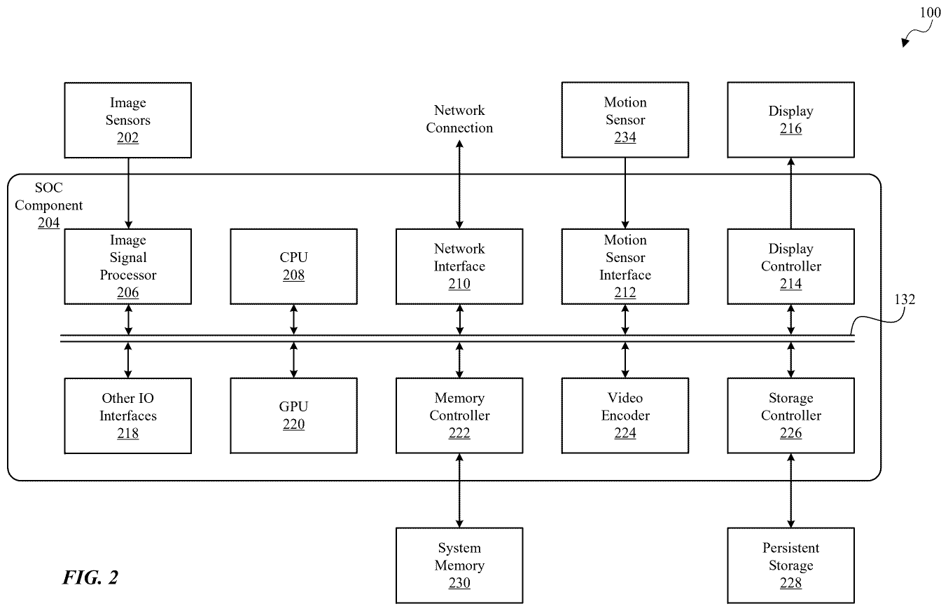

FIG. 2 is a block diagram illustrating components in device 100, according to some embodiments. Device 100 may perform various operations including image processing. For this and other purposes, device 100 may include image sensors 202, a system-on-a chip (SOC) component 204, a system memory 230, a persistent storage (e.g., flash memory) 228, an orientation sensor 234, and a display 216. The components as illustrated in FIG. 2 are merely illustrative. For example, device 100 may include other components (e.g., speaker or microphone) that are not illustrated in FIG. 2. Further, some components (e.g., orientation sensor 234) may be omitted from device 100.

Image sensors 202 are components for capturing image data. Each of image sensors 202 may be embodied, for example, as a complementary metal-oxide-semiconductor (CMOS) active-pixel sensor, a camera, video camera, or other devices. Image sensors 202 generate raw image data that is sent to SOC component 204 for further processing. In some embodiments, the image data processed by SOC component 204 is displayed on display 216, stored in system memory 230 and/or persistent storage 228, or sent to a remote computing device via a network connection. The raw image data generated by image sensors 202 may be in a Bayer color filter array (CFA) pattern (hereinafter also referred to as “Bayer pattern”) or a Quad Bayer pattern (hereinafter also referred to as a “Quadra pattern”). Image sensor 202 may also include optical and mechanical components that assist image sensing components (e.g., pixels) to capture images. The optical and mechanical components may include an aperture, a lens system, and an actuator that controls the focal length of image sensor 202.

Motion sensor 234 is a component or a set of components for sensing motion of device 100. Motion sensor 234 may generate sensor signals indicative of orientation and/or acceleration of device 100. The sensor signals are sent to SOC component 204 for various operations, such as turning on device 100 or rotating images displayed on display 216.

Display 216 is a component for displaying images as generated by SOC component 204. Display 216 may include, for example, a liquid crystal display (LCD) device or an organic light emitting diode (OLED) device. Based on data received from SOC component 204, display 116 may display various images, such as menus, selected operating parameters, images captured by image sensors 202 and processed by SOC component 204, and/or other information received from a user interface of device 100 (not shown).

System memory 230 is a component for storing instructions for execution by SOC component 204 and for storing data processed by SOC component 204. System memory 230 may be embodied as any type of memory including, for example, dynamic random access memory (DRAM), synchronous DRAM (SDRAM), double data rate (DDR, DDR2, DDR3, etc.) RAMBUS DRAM (RDRAM), static RAM (SRAM), or a combination thereof. In some embodiments, system memory 230 may store pixel data or other image data or statistics in various formats.

Persistent storage 228 is a component for storing data in a non-volatile manner. Persistent storage 228 retains data even when power is not available. Persistent storage 228 may be embodied as read-only memory (ROM), flash memory, or other non-volatile random access memory devices.

SOC component 204 is embodied as one or more integrated circuit (IC) chips and performs various data processing processes. SOC component 204 may include image signal processor (ISP) 206, a central processor unit (CPU) 208, a network interface 210, a motion sensor interface 212, a display controller 214, a graphics processor (GPU) 220, a memory controller 222, a video encoder 224, a storage controller 226, and various other input/output (I/O) interfaces 218, and bus 232 connecting these subcomponents. SOC component 204 may include more or fewer subcomponents than those shown in FIG. 2.

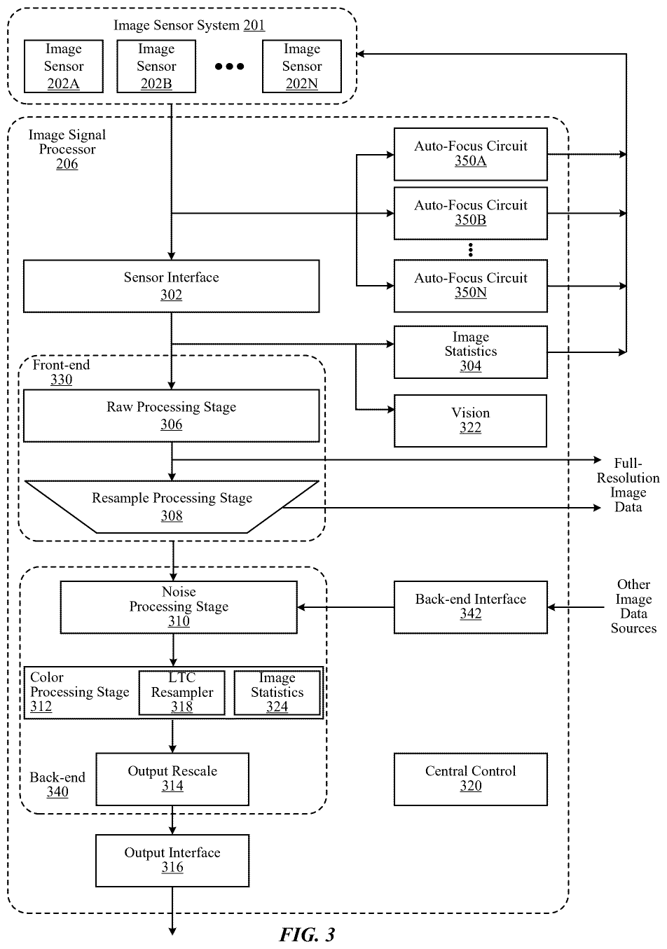

ISP 206 is hardware that performs various stages of an image processing pipeline. In some embodiments, ISP 206 may receive raw image data from image sensors 202 and process the raw image data into a form that is usable by other subcomponents of SOC component 204 or components of device 100. ISP 206 may perform various image-manipulation operations, such as image translation operations, horizontal and vertical scaling, color space conversion and/or image stabilization transformations, as described below in detail with reference to FIG. 3.

CPU 208 may be embodied using any suitable instruction set architecture and may be configured to execute instructions defined in that instruction set architecture. CPU 208 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 2, SOC component 204 may include multiple CPUs. In multiprocessor systems, each of the CPUs may commonly, but not necessarily, implement the same ISA.

Graphics processing unit (GPU) 220 is graphics processing circuitry for performing operations on graphical data. For example, GPU 220 may render objects to be displayed into a frame buffer (e.g., one that includes pixel data for an entire frame). GPU 220 may include one or more graphics processors that may execute graphics software to perform a part or all of the graphics operation, or hardware acceleration of certain graphics operations.

I/O interfaces 218 are hardware, software, firmware or combinations thereof for interfacing with various input/output components in device 100. I/O components may include devices, such as keypads, buttons, audio devices, and sensors (e.g., a global positioning system). I/O interfaces 218 process data for sending data to such I/O components or process data received from such I/O components.

Network interface 210 is a subcomponent that enables data to be exchanged among devices 100 and other devices via one or more networks (e.g., carrier or agent devices). For example, video or other image data may be received from other devices via network interface 210 and be stored in system memory 230 for subsequent processing (e.g., via a back-end interface to image signal processor 206, such as discussed below in FIG. 3) and display. The networks may include, Local Area Networks (LANs) (e.g., an Ethernet or corporate network) and Wide Area Networks (WANs). The image data received via network interface 210 may undergo image processing processes by ISP 206.

Motion sensor interface 212 is circuitry for interfacing with motion sensor 234. Motion sensor interface 212 receives sensor information from motion sensor 234 and processes the sensor information to determine the orientation or movement of device 100.

Display controller 214 is circuitry for sending image data to be displayed on display 216. Display controller 214 receives the image data from ISP 206, CPU 208, graphic processor or system memory 230 and processes the image data into a format suitable for display on display 216.

Memory controller 222 is circuitry for communicating with system memory 230. Memory controller 222 may read data from system memory 230 for processing by ISP 206, CPU 208, GPU 220, or other subcomponents of SOC component 204. Memory controller 222 may also write data to system memory 230 received from various subcomponents of SOC component 204.

Video encoder 224 is hardware, software, firmware, or a combination thereof for encoding video data into a format suitable for storing in persistent storage 228 or for passing the data to network interface 210 for transmission over a network to another device.

In some embodiments, one or more subcomponents of SOC component 204 or some functionality of these subcomponents may be performed by software components executed on ISP 206, CPU 208, or GPU 220. Such software components may be stored in system memory 230, persistent storage 228, or another device communicating with device 100 via network interface 210.

Image data or video data may flow through various data paths within SOC component 204. In one example, raw image data may be generated from image sensors 202 and processed by ISP 206 and then sent to system memory 230 via bus 232 and memory controller 222. After the image data is stored in system memory 230, it may be accessed by video encoder 224 for encoding or by display 116 for displaying via bus 232.

In another example, image data is received from sources other than image sensors 202. For example, video data may be streamed, downloaded, or otherwise communicated to SOC component 204 via wired or wireless network. The image data may be received via network interface 210 and written to system memory 230 via memory controller 222. The image data may then be obtained by ISP 206 from system memory 230 and processed through one or more image processing pipeline stages, as described below in detail with reference to FIG. 3. The image data may then be returned to system memory 230 or be sent to video encoder 224, display controller 214 (e.g., for display on display 216), or storage controller 226 for storage at persistent storage 228.

FIG. 3 is a block diagram illustrating image processing pipelines implemented using ISP 206, according to some embodiments. In some embodiments, ISP 206 is coupled to an image sensor system 201 that includes one or more image sensors 202A through 202N (hereinafter collectively referred to as “image sensors 202” or also referred individually as “image sensor 202”) to receive raw image data. Image sensor system 201 may include one or more sub-systems that control image sensors 202 individually. In some embodiments, each image sensor 202 may operate independently while, in other cases, image sensors 202 may share one or more components. For example, two or more image sensors 202 may share the same circuit board that controls the mechanical components of the image sensors (e.g., actuators that change the focal lengths of each image sensor). The image sensing components of image sensor 202 may include different types of image sensing components that may provide raw image data in different forms to ISP 206. For example, the image sensing components may include multiple focus pixels that are used for auto-focusing and multiple image pixels that are used for capturing images. In some embodiments, the image sensing pixels may be used for both auto-focusing and image capturing purposes.

ISP 206 implements an image processing pipeline which may include a set of stages that process image information from creation, capture, or receipt to output. ISP 206 may include a sensor interface 302, a central control 320, front-end pipeline stages 330, back-end pipeline stages 340, an image statistics module 304, a vision module 322, a back-end interface 342, an output interface 316, and auto-focus circuits 350A through 350N (hereinafter collectively referred to as “auto-focus circuits 350” or referred individually as “auto-focus circuits 350”). ISP 206 may include other components not illustrated in FIG. 3 or may omit one or more components illustrated in FIG. 3.

In some embodiments, different components of ISP 206 process image data at different rates. In some embodiments, front-end pipeline stages 330 (e.g., raw processing stage 306 and resample processing stage 308) may process image data at an initial data rate. Thus, the various different techniques, adjustments, modifications, or other processing operations may be performed by these front-end pipeline stages 330 at the initial data rate. For example, if front-end pipeline stages 330 process two pixels per clock cycle, then raw processing stage 306 operations (e.g., black level compensation, highlight recovery, and defective pixel correction) may process two pixels of image data at a time. In contrast, one or more back-end pipeline stages 340 may process image data at a different data rate less than the initial data rate. For example, in some embodiments, back-end pipeline stages 340 (e.g., noise processing stage 310, color processing stage 312, and output rescale 314) may be processed at a reduced data rate (e.g., one pixel per clock cycle).

Raw image data captured by image sensors 202 may be transmitted to different components of ISP 206 in different manners. In some embodiments, raw image data corresponding to the focus pixels may be sent to auto-focus circuits 350 while raw image data corresponding to the image pixels may be sent to sensor interface 302. In some embodiments, raw image data corresponding to both types of pixels may simultaneously be sent to both auto-focus circuits 350 and sensor interface 302.

Auto-focus circuits 350 may include a hardware circuit that analyzes raw image data to determine an appropriate focal length of each image sensor 202. In some embodiments, the raw image data may include data that is transmitted from image sensing pixels that perform image focusing operations. In some embodiments, raw image data from image capture pixels may also be used for auto-focusing purposes. Auto-focus circuit 350 may perform various image processing operations to generate data that determines the appropriate focal length. The image processing operations may include cropping, binning, image compensation, and scaling to generate data that is used for auto-focusing purposes, etc. The auto-focusing data generated by auto-focus circuits 350 may be fed back to image sensor system 201 to control the focal lengths of image sensors 202. For example, image sensor 202 may include a control circuit that analyzes the auto-focusing data to determine a command signal that is sent to an actuator associated with the lens system of image sensor 202 to change the focal length of image sensor 202. The data generated by auto-focus circuits 350 may also be sent to other components of ISP 206 for other image processing purposes. For example, some of the data may be sent to image statistics module 304 to determine information regarding auto-exposure.

Auto-focus circuits 350 may be individual circuits that are separate from other components, such as image statistics module 304, sensor interface 302, front-end 330, and back-end 340. This allows ISP 206 to perform auto-focusing analysis independent of other image processing pipelines. For example, ISP 206 may analyze raw image data from image sensor 202A to adjust the focal length of image sensor 202A using auto-focus circuit 350A while performing downstream image processing of the image data from image sensor 202B simultaneously. In some embodiments, the number of auto-focus circuits 350 may correspond to the number of image sensors 202. In other words, each image sensor 202 may have a corresponding auto-focus circuit that is dedicated to the auto-focusing of image sensor 202. Device 100 may perform auto focusing for different image sensors 202 even if one or more image sensors 202 are not in active use. This allows a seamless transition between two image sensors 202 when device 100 switches from one image sensor 202 to another. For example, device 100 may include a wide-angle camera and a telephoto camera as a dual back camera system for photo and image processing. Device 100 may display images captured by one of the dual cameras and may switch between the two cameras from time to time. The displayed images may seamless transition from image data captured by one image sensor 202 to image data captured by another image sensor 202 without waiting for second image sensor 202 to adjust its focal length because two or more auto-focus circuits 350 may continuously provide auto-focus data to image sensor system 201.

Raw image data captured by different image sensors 202 may also be transmitted to sensor interface 302. Sensor interface 302 receives raw image data from image sensors 202 and processes the raw image data into an image data processable by other stages in the pipeline. Sensor interface 302 may perform various preprocessing operations, such as image cropping, binning, and scaling, to reduce image data size. In some embodiments, pixels are sent from image sensors 202 to sensor interface 302 in raster order (e.g., horizontally, line by line). The subsequent processes in the pipeline may also be performed in raster order and the result may also be output in raster order. Although only a single image sensor system 201 and a single sensor interface 302 are illustrated in FIG. 3, when more than one image sensor system is provided by device 100, a corresponding number of sensor interfaces may be provided in ISP 206 to process raw image data from each image sensor system.

Front-end pipeline stages 330 process image data in raw or full-color domains. Front-end pipeline stages 330 may include raw processing stage 306 and resample processing stage 308. A raw image data may be in a Bayer raw image format or a Quadra raw image format, for example. In such raw image format, pixel data with values specific to a particular color (instead of all colors) is provided in each pixel. In an image capturing sensor, image data can be provided in the Bayer or Quadra pattern. Raw processing stage 306 may process image data in the Bayer or Quadra raw image format.

The operations performed by raw processing stage 306 include sensor linearization, black level compensation, fixed pattern noise reduction, defective pixel correction, raw noise filtering, lens shading correction, white balance gain, highlight recovery, and downsampling. Sensor linearization refers to mapping non-linear image data to linear space for other processing. Black level compensation refers to providing digital gain, offset, and clip independently for each color component (e.g., Gr, R, B, Gb) of the image data. Fixed pattern noise reduction refers to removing offset fixed pattern noise and gain fixed pattern noise by subtracting a dark frame from an input image and multiplying different gains to pixels. Defective pixel correction refers to detecting defective pixels, and then replacing defective pixel values. Raw noise filtering refers to reducing noise of image data by averaging neighboring pixels that are similar in brightness. Highlight recovery refers to estimating pixel values for those pixels that are clipped (or nearly clipped) from other channels. Lens shading correction refers to applying a gain per pixel to compensate for a dropoff in intensity roughly proportional to a distance from a lens optical center. White balance gain refers to providing digital gains for white balance, offset and clip independently for all color components (e.g., Gr, R, B, Gb in the Bayer pattern). Downsampling refers to reducing the resolution of an image (or certain regions thereof) by discarding pixels.

Components of ISP 206 may convert raw image data into image data in full-color domain, and thus raw processing stage 306 may process image data in the full-color domain in addition to or instead of raw image data.

Resample processing stage 308 performs various operations to convert, resample, or scale image data received from raw processing stage 306. Operations performed by resample processing stage 308 may include a demosaic operation, a per-pixel color correction operation, a Gamma mapping operation, a color space conversion, and a downscaling or sub-band splitting. The demosaic operation refers to converting or interpolating missing color samples from raw image data (e.g., in the Bayer pattern) to output image data into a full-color domain. The demosaic operation may include low pass directional filtering on the interpolated samples to obtain full-color pixels. The per-pixel color correction operation refers to a process of performing color correction on a per-pixel basis using information about relative noise standard deviations of each color channel to correct color without amplifying noise in the image data. The Gamma mapping operation refers to converting image data from input image data values to output data values to perform gamma correction. For the purpose of the Gamma mapping operation, lookup tables (or other structures that index pixel values to another value) for different color components or channels of each pixel (e.g., a separate lookup table for R, G, and B color components) may be used. The color space conversion refers to converting color space of an input image data into a different format. In some embodiments, resample processing stage 308 converts RGB format into YCbCr format for further processing.

Central control module 320 may control and coordinate overall operation of other components in ISP 206. Central control module 320 performs operations including monitoring various operating parameters (e.g., logging clock cycles, memory latency, quality of service, and state information), updating or managing control parameters for other components of ISP 206, and interfacing with sensor interface 302 to control the starting and stopping of other components of ISP 206. For example, central control module 320 may update programmable parameters for other components in ISP 206 while the other components are in an idle state. After updating the programmable parameters, central control module 320 may place these components of ISP 206 into a run state to perform one or more operations or tasks. Central control module 320 may also instruct other components of ISP 206 to store image data (e.g., by writing to system memory 230 in FIG. 2) before, during, or after resample processing stage 308. In this way, full-resolution image data in raw or full-color domain format may be stored in addition to or instead of processing the image data output from resample processing stage 308 through backend pipeline stages 340.

Image statistics module 304 performs various operations to collect statistics information associated with the image data. The operations for collecting the statistics information may include sensor linearization, replacing patterned defective pixels, subsampling raw image data, detection and replacement of non-patterned defective pixels, black level compensation, lens shading correction, and inverse black level compensation. After performing one or more of such operations, statistics information (e.g., 3A statistics (auto-focus, auto white balance (AWB), auto exposure (AE)), histograms (e.g., 2D color or component), and any other image data information) may be collected or tracked. In some embodiments, certain pixels' values or areas of pixel values may be excluded from collections of certain statistics data when preceding operations identify clipped pixels. Although only a single statistics module 304 is illustrated in FIG. 3, multiple image statistics modules may be included in ISP 206. For example, each image sensor 202 may correspond to an individual image statistics module 304. In some embodiments, each statistic module may be programmed by central control module 320 to collect different information for the same or different image data.

Vision module 322 performs various operations to facilitate computer vision operations at CPU 208, such as facial detection in image data. Vision module 322 may perform various operations including pre-processing, global tone-mapping and Gamma correction, vision noise filtering, resizing, keypoint detection, generation of histogram-of-orientation gradients (HOG), and normalized cross correlation (NCC). The pre-processing may include a subsampling or binning operation and computation of luminance if the input image data is not in YCrCb format. Global mapping and Gamma correction can be performed on the pre-processed data on luminance image. Vision noise filtering is performed to remove pixel defects and reduce noise present in the image data, and thereby improve the quality and performance of subsequent computer vision algorithms. Such vision noise filtering may include detecting and fixing dots or defective pixels and performing bilateral filtering to reduce noise by averaging neighboring pixels of similar brightness. Various vision algorithms use images of different sizes and scales. Resizing of an image is performed, for example, by binning or linear interpolation operation. Keypoints are locations within an image that are surrounded by image patches well suited to matching in other images of the same scene or object. Such keypoints are useful in image alignment, computing camera pose, and object tracking. Keypoint detection refers to the process of identifying such keypoints in an image. HOG provides descriptions of image patches for tasks in image analysis and computer vision. HOG can be generated, for example, by (i) computing horizontal and vertical gradients using a difference filter, (ii) computing gradient orientations and magnitudes from the horizontal and vertical gradients, and (iii) binning the gradient orientations. NCC is the process of computing spatial cross-correlation between a patch of image and a kernel.

Back-end interface 342 receives image data from other image sources than image sensor 102 and forwards the image data to other components of ISP 206 for processing. For example, image data may be received over a network connection and be stored in system memory 230. Back-end interface 342 retrieves the image data stored in system memory 230 and provides the image data to back-end pipeline stages 340 for processing. Back-end interface 342 may convert the retrieved image data to a format that can be utilized by back-end processing stages 340. For instance, back-end interface 342 may convert RGB, YCbCr 4:2:0, or YCbCr 4:2:2 formatted image data into YCbCr 4:4:4 color format.

Back-end pipeline stages 340 processes image data according to a particular full-color format (e.g., YCbCr 4:4:4 or RGB). In some embodiments, components of the back-end pipeline stages 340 may convert image data to a particular full-color format before further processing. Back-end pipeline stages 340 may include noise processing stage 310 and color processing stage 312. Back-end pipeline stages 340 may include other stages not illustrated in FIG. 3.

Noise processing stage 310 performs various operations to reduce noise in the image data. The operations performed by noise processing stage 310 include color space conversion, gamma/de-gamma mapping, temporal filtering, noise filtering, luma sharpening, and chroma noise reduction. The color space conversion may convert an image data from one color space format to another color space format (e.g., RGB format converted to YCbCr format). Gamma/de-gamma operation converts image data from input image data values to output data values to perform gamma correction or reverse gamma correction. Temporal filtering filters noise using a previously-filtered image frame to reduce noise. For example, pixel values of a prior image frame are combined with pixel values of a current image frame. Noise filtering may include, for example, spatial noise filtering. Luma sharpening may sharpen luma values of pixel data while chroma suppression may attenuate chroma to gray (e.g., no color). In some embodiments, the luma sharpening and chroma suppression may be performed simultaneously with spatial nose filtering. The aggressiveness of noise filtering may be determined differently for different regions of an image. Spatial noise filtering may be included as part of a temporal loop implementing temporal filtering. For example, a previous image frame may be processed by a temporal filter and a spatial noise filter before being stored as a reference frame for a next image frame to be processed. In some embodiments, spatial noise filtering may not be included as part of the temporal loop for temporal filtering (e.g., the spatial noise filter may be applied to an image frame after it is stored as a reference image frame and thus the reference frame is not spatially filtered).

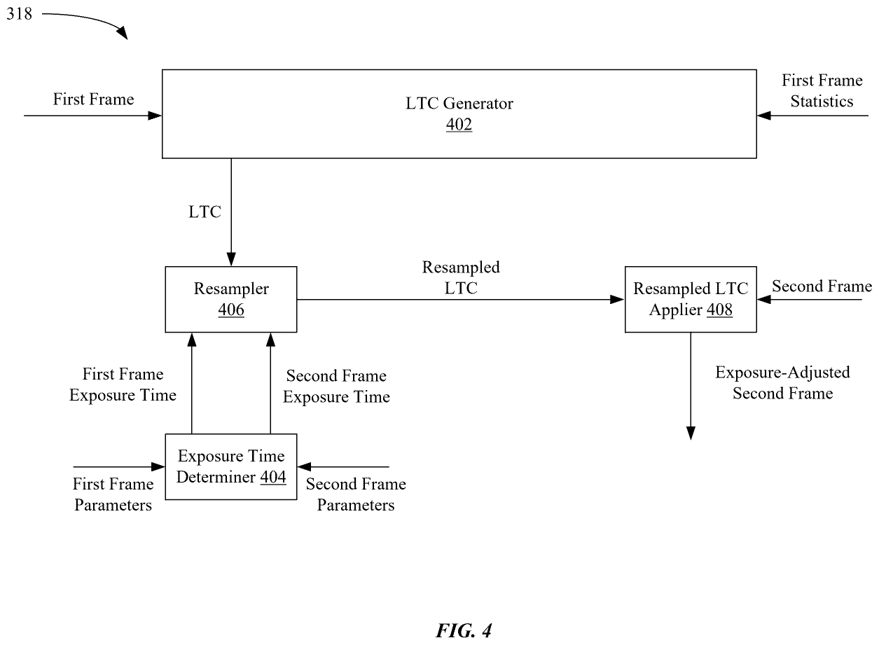

Color processing stage 312 may perform various operations associated with adjusting color information in the image data. The operations performed in color processing stage 312 include local tone mapping, gain/offset/clip, color correction, three-dimensional color lookup, gamma conversion, and color space conversion. Local tone mapping refers to spatially varying local tone curves in order to provide more control when rendering an image. For instance, a two-dimensional grid of tone curves (which may be programmed by central control module 320) may be bilinearly interpolated such that smoothly varying tone curves are created across an image. In some embodiments, local tone mapping may also apply spatially varying and intensity varying color correction matrices, which may, for example, be used to make skies bluer while turning down blue in the shadows in an image. Digital gain/offset/clip may be provided for each color channel or component of image data. Color correction may apply a color correction transform matrix to image data. 3D color lookup may utilize a three-dimensional array of color component output values (e.g., R, G, B) to perform advanced tone mapping, color space conversions, and other color transforms. Gamma conversion may be performed, for example, by mapping input image data values to output data values in order to perform gamma correction, tone mapping, or histogram matching. Color space conversion may be implemented to convert image data from one color space to another (e.g., RGB to YCbCr). Other processing techniques may also be performed as part of color processing stage 312 to perform other imaging operations, including black and white conversion, sepia tone conversion, negative conversion, or solarize conversion. A local tone curve resampler 318 in color processing stage 312 may resample a local tone curve of a first frame to match the exposure time of a second frame and apply the resampled local tone curve to the second frame. The foregoing operations may be performed to reduce various artifacts, such as frame-to-frame flicker. Details about a structure and operation of local tone curve resampler 318 are provided in relation to FIGS. 4-9. An image statistics module 324 in color processing stage 312 may be configured to determine various image statistics of image. Such image statistics may include, for example, brightness-related statistics for different regions of image frames and a histogram for each of the regions. The brightness-related statistics for a particular region may include brightness values determined for pixels in the region. The brightness-related statistics may also include target brightness values for the pixels in the region.

Output rescale module 314 may resample, transform, and correct distortion on the fly as ISP 206 processes image data. Output rescale module 314 may compute a fractional input coordinate for each pixel and use this fractional coordinate to interpolate an output pixel via a polyphase resampling filter. A fractional input coordinate may be produced from a variety of possible transforms of an output coordinate, such as resizing or cropping an image (e.g., via a simple horizontal and vertical scaling transform), rotating and shearing an image (e.g., via non-separable matrix transforms), perspective warping (e.g., via an additional depth transform) and per-pixel perspective divides applied in piecewise in strips to account for changes in image sensor during image data capture (e.g., due to a rolling shutter), and geometric distortion correction (e.g., via computing a radial distance from the optical center in order to index an interpolated radial gain table, and applying a radial perturbance to a coordinate to account for a radial lens distortion).

Output rescale module 314 may apply transforms to image data as it is processed at output rescale module 314. Output rescale module 314 may include horizontal and vertical scaling components. The vertical portion of the design may implement a series of image data line buffers to hold the “support” needed by the vertical filter. As ISP 206 may be a streaming device, it may be that only the lines of image data in a finite-length sliding window of lines are available for the filter to use. Once a line has been discarded to make room for a new incoming line, the line may be unavailable. Output rescale module 314 may statistically monitor computed input Y coordinates over previous lines and use it to compute an optimal set of lines to hold in the vertical support window. For each subsequent line, output rescale module may automatically generate a guess as to the center of the vertical support window. In some embodiments, the output rescale module 314 may implement a table of piecewise perspective transforms encoded as digital difference analyzer (DDA) steppers to perform a per-pixel perspective transformation between an input image data and output image data in order to correct artifacts and motion caused by sensor motion during the capture of the image frame. Output rescale may provide image data via output interface 316 to various other components of device 100, as discussed above with reference to FIGS. 1 and 2.

In some embodiments, the functionally of components 302 through 350 may be performed in a different order than the order implied by the order of these functional units in the image processing pipeline illustrated in FIG. 3 or may be performed by different functional components than those illustrated in FIG. 3. Moreover, the various components as described in FIG. 3 may be embodied in various combinations of hardware, firmware, or software.

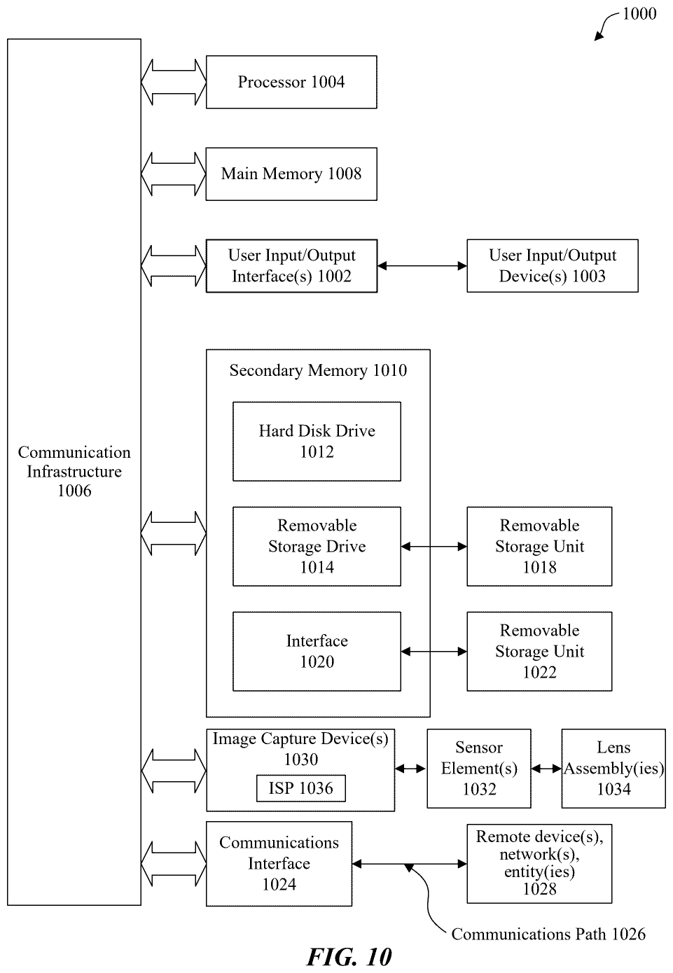

FIG. 4 is a block diagram of local tone curve resampler 318, according to some embodiments. As shown in FIG. 4, local tone curve resampler 318 includes a local tone curve generator 402, an exposure time determiner 404, a resampler 406, and a resampled local tone curve applier 408. Local tone curve generator 402, exposure time determiner 404, resampler 406, and resampled local tone curve applier 408 may be implemented by processing logic that can include hardware (e.g., circuitry, dedicated logic, programmable logic, and/or microcode), software (e.g., instructions executing on a processing device), or a combination thereof. In some embodiments, each of local tone curve generator 402, exposure time determiner 404, resampler 406, and resampled local tone curve applier 408 is implemented in one or more software processes executing on one or more processor-based computer systems, such as computer system 1000 as described below in reference to FIG. 10.

Local tone curve generator 402 may be configured to obtain a first frame of a video stream captured by an image sensor (e.g., image sensors 202). In one example, the first frame is from a video stream that is pre-recorded, stored in, and retrieved from, for example, persistent storage 228 or system memory 230. In another example, the first frame is from a video stream that is captured in a live view mode (also referred to a “live preview” mode) of device 100, where the image formed by a lens of device 100 is continuously projected onto image sensors 202 and displayed via display 216 while the camera of device 100 is activated, but the record mode of the camera is not activated. That is, a current view of the environment, as perceived by image sensors 202, is presented to the user via display 216 without activating the record mode.

Local tone curve generator 402 may also be configured to obtain image statistics, for example, from image statistics module 304 or image statistics module 324. Such image statistics may include, for example, brightness-related statistics for different regions of the first frame and a histogram for each of the regions. The brightness-related statistics for a particular region may include brightness values determined for pixels in the region. The brightness-related statistics may also include target brightness values for the pixels in the region. The target brightness values may be considered to have a compressed dynamic range as compared to the determined brightness values of the pixels in the region. The histogram for a particular region of the first frame may represent a distribution of luminance (e.g., lightness or brightness) for pixels within the region across multiple luminance levels. For example, a histogram may include a number of bins, each corresponding to a different luminance range. The value for each bin may represent the percentage of pixels within the block that have a luminance value within the luminance range corresponding to that bin.

Local tone curve generator 402 may be configured to generate a respective local tone curve for each of the different regions of the first frame based on such statistics. A local tone curve generated for a particular region may represent the desired tonal or brightness range for that region. In some embodiments, a representation of the local tone curves are stored in a memory (e.g., system memory 230). For example, each local tone curve may include control points or nodes (e.g., 65 control points or nodes) that are represented by a look-up table with 65 entries of 16-bit values. The value at each node may represent the output brightness level mapped to the input brightness level for that node. The look-up tables may be sampled in a uniform or non-uniform fashion (e.g., logarithmically or exponentially).

Exposure time determiner 404 may be configured to obtain image capturing parameters associated with the first frame and a second frame that is captured subsequent to the first frame. The second frame may be the next consecutive frame that is captured after the first frame or may be the Nth frame captured after the first frame, where N is any positive integer. Examples of the image capturing parameters include, for example, a shutter time utilized when the first frame and the second frame were captured by image sensors 220, an automatic gain control setting utilized when the first frame and the second frame were captured by image sensor 220, a digital gain setting utilized when the first frame and the second frame were captured by the image sensor, and a gain down ratio utilized when the first frame and the second frame were captured by image sensors 220.

Exposure time determiner 404 may be configured to determine the exposure time for a particular region of the first frame based on the image parameters associated with the first frame and determine the exposure time for a corresponding region (including the same object or subject) of the second frame based on the image parameters associated with the second frame. The exposure time may be representative of how long image sensors 220 are exposed to light while capturing an image. In digital photography, the exposure time is equivalent to the integration time of a camera, which refers to a duration over which an image sensor collects and accumulates incoming light. As such, exposure time is also referred herein as an “equivalent integration time.” In some embodiments, the exposure time for a region of a particular frame may be determined as a product of a shutter time utilized when the particular frame was captured, an automatic gain control setting utilized when the particular frame was captured, and a digital gain setting utilized when the particular frame was captured, where the product is divided by a gain down ratio utilized when the particular frame was captured.

The exposure time for a particular region increases frame to frame as the lighting conditions decrease frame to frame, and the exposure time for a particular region decreases frame to frame as the lighting conditions increase frame to frame. The input brightness range and the exposure time have an inverse relationship. Accordingly, when the exposure time increases, the input brightness range of the local tone curve decreases. Conversely, when the exposure time decreases, the input brightness range of the local tone curve increases.

For a given region of the first frame and the second frame, resampler 406 may be configured to determine a change between the determined exposure time of the particular region of the first frame and the determined exposure time of the corresponding region of the second frame. Based on the determined change, resampler 406 may resample the local tone curve generated for the first frame to match the exposure time of the second frame. For instance, resampler 406 may generate a new local tone curve for the first frame that has the same input brightness range as the second frame. The output brightness value mapped to a particular brightness value in the input brightness range of the new local tone curve may be determined using a resample ratio. For instance, the output brightness values of the original local tone curve (e.g., the values of the nodes of the local tone curve) generated for the first frame may be resampled based on the resample ratio. In some embodiments, the resample ratio is equal to a ratio between the first exposure time and the second exposure time.

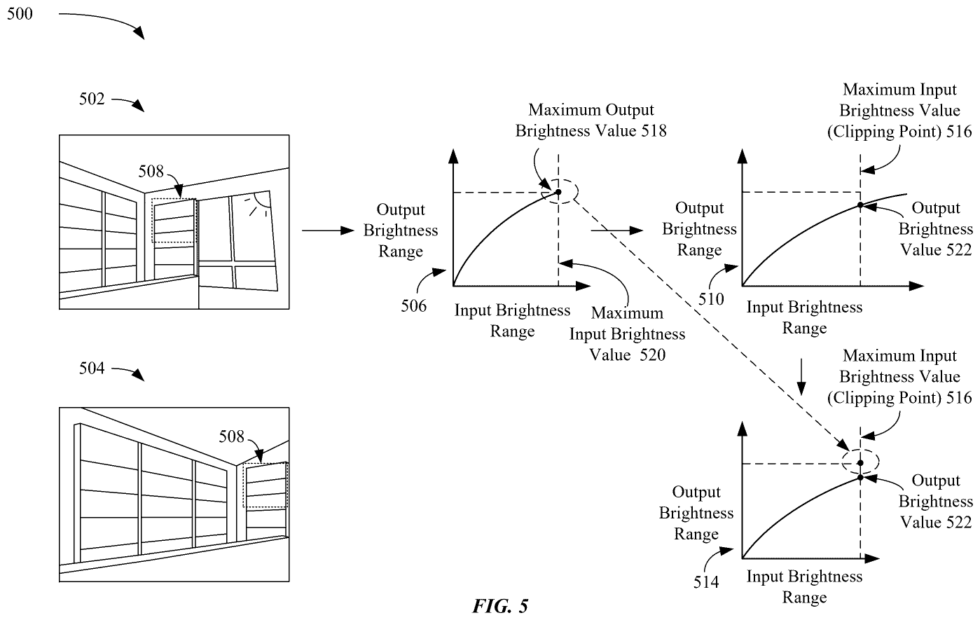

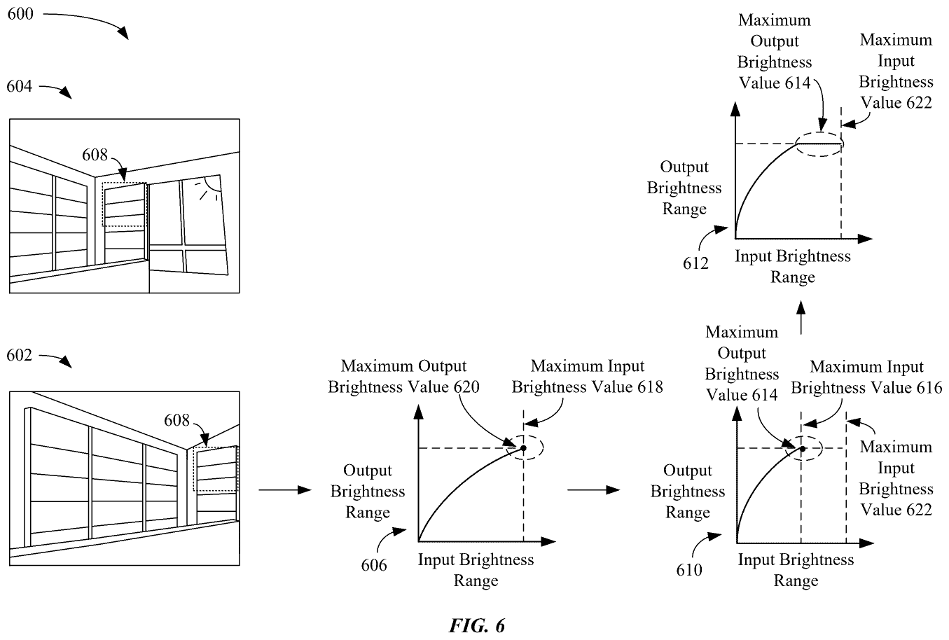

Each input brightness value of the original local tone curve may be multiplied by the resample ratio. The output brightness value mapped to the original input brightness value is then mapped to the new input brightness range of the new local tone curve. The resulting local tone curve may be further modified based on whether the exposure time for the second frame is longer or shorter than the exposure time for the first frame. Additional details regarding the resampling of local tone curves are described below with reference to FIGS. 5 and 6.

Resampled local tone curve applier 408 may be configured to apply the resampled local tone curve to the second frame to generate an exposure-adjusted second frame. For example, resampled local tone curve applier 408 may perform local tone mapping. In accordance with such an example, resampled local tone curve applier 408 may operate on each pixel in a particular region of the second frame to determine a brightness value (e.g., the input brightness value) based on the red, green, and blue pixel values for the pixel. The luminance value may then be indexed into an interpolated look-up table representative of the resampled local tone curve to determine a tone-mapped luminance value (e.g., the output brightness value mapped to the input brightness value). The interpolated look-up table may be based on local tone curves of regions that neighbor the particular region. The red, green, and blue pixel intensities for the pixel may be gained by the ratio between the input brightness value and the output brightness value. The foregoing process is performed for each pixel in each region of the second frame to generate the exposure-adjusted second frame. The exposure-adjusted second frame may be displayed, for example, by display 216.

FIG. 5 is a diagram 500 illustrating the resampling of a local tone curve for a particular region of a frame based on the exposure time increasing frame to frame, according to some embodiments. As shown in FIG. 5, diagram 500 includes a first frame 502 of a video stream and a second frame 504 of the video stream. Second frame 504 is captured by an image sensor subsequent to first frame 502.

In the example shown in FIG. 5, a user pans from right to left while recording a video or while in the live view mode of device 100. As further shown in FIG. 5, first frame 502 includes a region 508, and second frame 504 includes a corresponding region 508 that includes the same object or subject as in region 508 of first frame 502. FIG. 5 further shows a graph illustrating a local tone curve 506 generated for region 508 of first frame 502, for example, by local tone curve generator 402. The graph includes an x-axis representative of the input brightness range for region 508 of first frame 502 and a y-axis representative of the output brightness range of region 508 of first frame 502.

The lighting conditions decrease as the user pans to the left because the light source (e.g., the Sun) visible via the window in first frame 502 is no longer visible in second frame 504. Accordingly, the exposure time is longer for second frame 504 to capture more light.

Resampler 406 may determine that the exposure time of second frame 504 is longer than the exposure time of first frame 502 and resample local tone curve 506 of first frame 502 to match the exposure time of second frame 504. To match the exposure time of second frame 504, resampler 406 may increase the input brightness range based on the exposure time of second frame 504. The resulting local tone curve is shown as resampled local tone curve 510. To generate resampled local tone curve 510, each input brightness value of the original local tone curve 506 may be multiplied by the resample ratio (e.g., having a value greater than 1), as described above. The output brightness value mapped to each original input brightness value of local tone curve 506 is then mapped to the new input brightness values of resampled local tone curve 510.

Resampled local tone curve 510 extends past the maximum input brightness value 516 of its input brightness range. Accordingly, resampler 406 may clip resampled local tone curve 510 at a clipping point corresponding to maximum input brightness value 516 to generate a clipped local tone curve 514. As shown in clipped local tone curve 514, the output brightness value 522 mapped to the maximum input brightness value 516 is smaller than the output brightness value 518 mapped to the maximum input brightness value 520 of local tone curve 506. This causes an undesired gray-colored flicker effect between first frame 502 and second frame 504 if applied to second frame 504. To mitigate this flicker effect, resampler 406 may set the output brightness value 522 mapped to maximum input brightness value 516 of clipped local tone curve 514 to equal the output brightness value (e.g., maximum output brightness value 518) mapped to the maximum input brightness value 520 of local tone curve 506. Resampled local tone curve applier 408 may apply the resulting local tone curve (e.g., local tone curve 514) to second frame 504 to generate an exposure-adjusted second frame.

FIG. 6 is a diagram 600 illustrating the resampling of a local tone curve for a particular region of a frame based on the exposure time decreasing frame to frame, according to some embodiments. As shown in FIG. 6, diagram 600 includes a first frame 602 of a video stream and a second frame 604 of the video stream. Second frame 604 is captured by an image sensor subsequent to first frame 602.

In the example shown in FIG. 6, a user pans from left to right while recording a video or while in the live view mode of device 100. As further shown in FIG. 6, first frame 602 includes a region 608, and second frame 604 includes a corresponding region 608 that includes the same object or subject as in region 608 of first frame 602. FIG. 6 further shows a graph illustrating a local tone curve 606 generated for region 608 of first frame 602, for example, by local tone curve generator 402. The graph includes an x-axis representative of the input brightness range for region 608 of first frame 602 and a y-axis representative of the output brightness range of region 608 of second frame 604.

The lighting conditions increase as the user pans to the right because the light source (e.g., the Sun) in second frame 604 becomes visible. Accordingly, the exposure time is decreased for second frame 604 to capture less light.

Resampler 406 may determine that the exposure time of second frame 604 is shorter than the exposure time of first frame 602 and resample the local tone curve of first frame 602 to match the exposure time of second frame 604. To match the exposure time of second frame 604, resampler 406 may decrease the input brightness range based on the exposure time of second frame 604. The resulting local tone curve is shown as resampled local tone curve 610. To generate resampled local tone curve 610, each input brightness value of the original local tone curve 606 may be multiplied by the resample ratio (e.g., having a value less than 1), as described above. The output brightness value mapped to each original input brightness value of local tone curve 606 is then mapped to the new input brightness values of resampled local tone curve 610.

As shown in FIG. 6, resampled local tone curve 610 includes a maximum output brightness value 614 that is mapped to a maximum input brightness value 616 that is less than the maximum input brightness value 618 of local tone curve 606. Maximum output brightness value 614 is equal to the maximum output brightness value 620 of local tone curve 606. Resampler 406 may extend the input brightness range of resampled local tone curve 610 beyond the maximum input brightness value 616. The input brightness range of resampled local tone curve 610 may be extended to match the input brightness range of local tone curve 606 (e.g., maximum input brightness value 616 of resampled local tone curve 610 is extended from maximum input brightness value 616 to maximum input brightness value 622 to be equal to maximum input brightness value 618 of local tone curve 606). Resampler 406 may map the maximum output brightness value 614 of resampled local tone curve 610 to each input brightness value of the first input range of brightness values extended beyond maximum input brightness value 616 to generate local tone curve 612. By preserving the maximum output brightness value 620 in the extended region, an undesired gray-colored flicker effect between first frame 602 and second frame 604 is mitigated. Resampled local tone curve applier 408 may apply the local tone curve 614 to second frame 604 to generate an exposure-adjusted second frame.

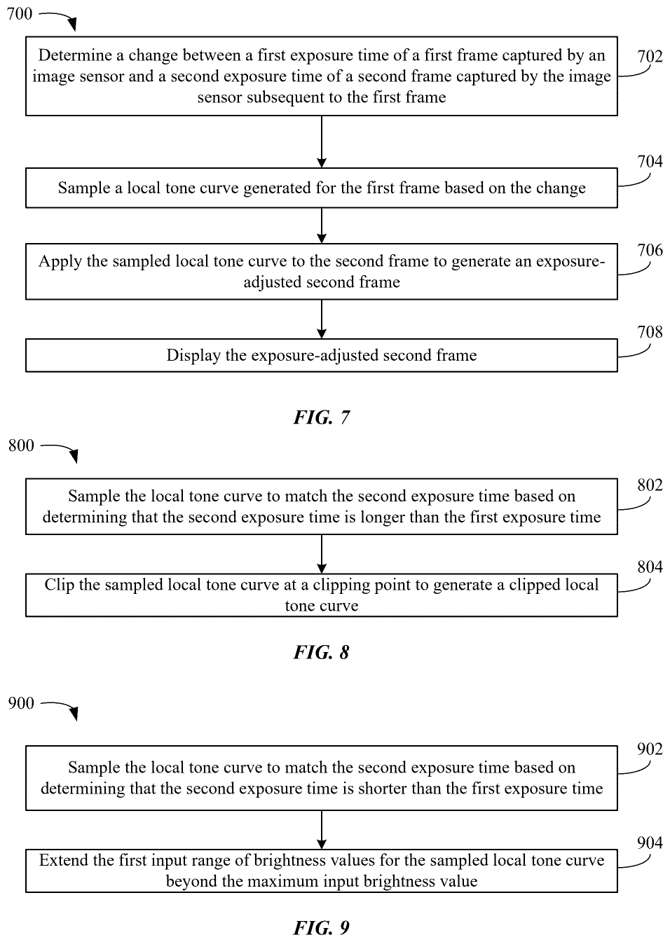

FIG. 7 is a flowchart of a method 700 for generating an exposure-adjusted frame, according to some embodiments. Method 700 can be performed by processing logic that can include hardware (e.g., circuitry, dedicated logic, programmable logic, and microcode), software (e.g., instructions executing on a processing device), or a combination thereof. It is to be appreciated that not all operations may be performed simultaneously, or in a different order than shown in FIG. 7, as will be understood by a person of ordinary skill in the art.

Method 700 shall be described with reference to FIGS. 2 and 4-6. Method 700 is not limited to that example embodiment.

In 702, resampler 406 may determine a change between a first exposure time of a first frame captured by an image sensor and a second exposure time of a second frame captured by the image sensor subsequent to the first frame. For example, resampler 406 may obtain the first and second exposure times from exposure time determiner 404 and determine a ratio between the first and second exposure times. If the ratio is equal to 1, then resampler 406 determines that there is no change in exposure times. If the ratio is a value other than 1, then resampler 406 determines that there is change between the first and second exposure times.

In some embodiments, the first exposure time is determined based on at least one of a first shutter time utilized when the first frame is captured by the image sensor (e.g., image sensors 220), a first automatic gain control setting utilized when the first frame is captured by the image sensor, a first digital gain setting utilized when the first frame is captured by the image sensor, or a first gain down ratio utilized when the first frame is captured by the image sensor. The second exposure time is determined based on at least one of a first shutter time utilized when the second frame is captured by the image sensor (e.g., image sensors 220), a first automatic gain control setting utilized when the second frame is captured by the image sensor, a first digital gain setting utilized when the second frame is captured by the image sensor, or a first gain down ratio utilized when the second frame is captured by the image sensor.

In 704, resampler 406 may sample a local tone curve generated for the first frame based on the change. For example, referring to FIG. 5, resampler 406 may sample local tone curve 506 generated for first frame 502 based on determining that the second exposure time of second frame 504 is longer than the first exposure time of first frame 502. In another example, referring to FIG. 6, resampler 406 may sample local tone curve 606 generated for first frame 602 based on determining that the second exposure time of second frame 604 is shorter than the first exposure time of first frame 602. Additional details regarding sampling the local tone curve based on the change in exposure times are provided below with reference to FIGS. 8 and 9.

In 706, resampled local tone curve applier 408 may apply the sampled local tone curve to the second frame to generate an exposure-adjusted second frame. For example, referring to FIG. 5, resampled local tone curve applier 408 may apply the local tone curve 514 to second frame 504 to generate an exposure-adjusted second frame. In another example, referring to FIG. 6, resampled local tone curve applier 408 may apply local tone curve 612 to second frame 604 to generate an exposure-adjusted second frame.

In 708, display 216 may display the exposure-adjusted second frame.

FIG. 8 is a flowchart of a method 800 for sampling a local tone curve generated for a first frame based on a determination that the exposure time of a second frame is longer than the exposure time of the first frame, according to some embodiments. Method 800 can be performed by processing logic that can include hardware (e.g., circuitry, dedicated logic, programmable logic, and microcode), software (e.g., instructions executing on a processing device), or a combination thereof. It is to be appreciated that not all operations may be needed to perform the disclosure provided herein. Further, some of the operations may be performed simultaneously, or in a different order than shown in FIG. 8, as will be understood by a person of ordinary skill in the art.

Method 800 shall be described with reference to FIGS. 4 and 5. Method 800 is not limited to that example embodiment.

In 802, resampler 406 may sample the local tone curve to match the second exposure time based on determining that the second exposure time is longer than the first exposure time, where to match the second exposure time, a first input range of brightness values for the sampled local tone curve is increased based on the second exposure time. For example, referring to FIG. 5, resampler 406 may sample local tone curve 506 of first frame 502 to match the exposure time of second frame 504. To match the exposure time of second frame 504, resampler 406 may increase the input brightness range of local tone curve 506 based on the exposure time of second frame 504. The resulting local tone curve is shown as resampled local tone curve 510.

In 804, resampler 406 may clip the sampled local tone curve at a clipping point to generate a clipped local tone curve. In some embodiments, the clipping point corresponds to a first maximum input brightness value of a second input range of brightness values of the local tone curve generated for the first frame. For example, referring to FIG. 5, resampled local tone curve 510 extends past the maximum input brightness value 516 of its input brightness range. Accordingly, resampler 406 may clip resampled local tone curve 510 at a clipping point corresponding to maximum input brightness value 516 to generate a clipped local tone curve 514.

In some embodiments, the clipped local tone curve includes a first output brightness value mapped to a first maximum input brightness value and the local tone curve generated for the first frame includes a second input brightness value. Resampler 406 may increase the first output brightness value to equal the second output brightness value. For example, referring to FIG. 5, resampler 406 may increase the output brightness value mapped to maximum input brightness value 516 of clipped local tone curve 510 from output brightness value 522 to equal the output brightness value (e.g., maximum output brightness value 518) mapped to the maximum input brightness value 520 of local tone curve 506.

FIG. 9 is a flowchart of a method 900 for sampling a local tone curve generated for a first frame based on a determination that the exposure time of a second frame is shorter than the exposure time of the first frame, according to some embodiments. Method 900 can be performed by processing logic that can include hardware (e.g., circuitry, dedicated logic, programmable logic, and microcode), software (e.g., instructions executing on a processing device), or a combination thereof. It is to be appreciated that not all operations may be needed to perform the disclosure provided herein. Further, some of the operations may be performed simultaneously, or in a different order than shown in FIG. 9, as will be understood by a person of ordinary skill in the art.

Method 900 shall be described with reference to FIGS. 4 and 6. Method 900 is not limited to that example embodiment.

In 902, resampler 406 may sample the local tone curve to match the second exposure time based on determining that the second exposure time is shorter than the first exposure time, where to match the second exposure time, a first input range of brightness values for the sampled local tone curve is decreased based on the second exposure time, and where the sampled local tone curve includes a maximum output brightness value mapped to a maximum input brightness value of the first input range of brightness values. For example, referring to FIG. 6, resampler 406 may determine that the exposure time of second frame 604 is shorter than the exposure time of first frame 602 and resample the local tone curve of first frame 602 to match the exposure time of second frame 604. To match the exposure time of second frame 604, resampler 406 may decrease the input brightness range based on the exposure time of second frame 604. The resulting local tone curve is shown as resampled local tone curve 610. As further shown in FIG. 6, resampled local tone curve 610 includes a maximum output brightness value 614 that is mapped to a maximum input brightness value 616 that is less than the maximum input brightness value 618 of local tone curve 606. Maximum output brightness value 614 is equal to the maximum output brightness value 620 of local tone curve 606.

In 904, resampler 406 may extend the first input range of brightness values for the sampled local tone curve beyond the maximum input brightness value. For example, referring to FIG. 6, resampler 406 may extend the input brightness range of resampled local tone curve 610 beyond the maximum input brightness value 616. The input brightness range of resampled local tone curve 610 may be extended from maximum input brightness value 616 to maximum input brightness value 622 to match the input brightness range of local tone curve 606 (e.g., maximum input brightness value 622 of resampled local tone curve 610 becomes equal to maximum input brightness value 618 of local tone curve 606).

In some embodiments, resampler 406 may map the maximum output brightness value to each input brightness value of the first input range of brightness values extended beyond the maximum input brightness value. For example, referring to FIG. 6, resampler 406 may map the maximum output brightness value 614 of resampled local tone curve 610 to each input brightness value of the first input range of brightness values extended beyond maximum input brightness value 616 to generate local tone curve 612.

Various aspects can be implemented, for example, using one or more computer systems, such as computer system 1000 shown in FIG. 10. Computer system 1000 can be any computer capable of performing the functions described herein, such as the functions of device 100 of FIGS. 1 and 2, image signal processor 206 of FIG. 3, local tone curve resampler 315 (and the components thereof), as respectively described with reference to FIGS. 3-6, and the operations of FIGS. 7-8. Computer system 1000 includes one or more processors (also called central processing units, or CPUs), such as a processor 1004. Processor 1004 is connected to a communication infrastructure 1006 (e.g., a bus). Computer system 1000 also includes user input/output device(s) 1003, such as monitors, keyboards, and pointing devices, that communicate with communication infrastructure 1006 through user input/output interface(s) 1002. Computer system 1000 also includes a main or primary memory 1008, such as random access memory (RAM). Main memory 1008 may include one or more levels of cache. Main memory 1008 has stored therein control logic (e.g., computer software) and/or data.

Computer system 1000 may also include one or more secondary storage devices or memory 1010. Secondary memory 1010 may include, for example, a hard disk drive 1012 and/or a removable storage device or drive 1014. Removable storage drive 1014 may be a floppy disk drive, a magnetic tape drive, a compact disk drive, an optical storage device, tape backup device, and/or any other storage device/drive.

Removable storage drive 1014 may interact with a removable storage unit 1018. Removable storage unit 1018 includes a computer usable or readable storage device having stored thereon computer software (control logic) and/or data. Removable storage unit 1018 may be a floppy disk, magnetic tape, compact disk, DVD, optical storage disk, and/or any other computer data storage device. Removable storage drive 1014 reads from and/or writes to removable storage unit 1018 in a well-known manner.

According to some aspects, secondary memory 1010 may include other means, instrumentalities or other approaches for allowing computer programs and/or other instructions and/or data to be accessed by computer system 1000. Such means, instrumentalities or other approaches may include, for example, a removable storage unit 1022 and an interface 1020. Examples of the removable storage unit 1022 and the interface 1020 may include a program cartridge and cartridge interface (e.g., such as that found in video game devices), a removable memory chip (e.g., an EPROM or PROM) and associated socket, a memory stick and USB port, a memory card and associated memory card slot, and/or any other removable storage unit and associated interface.

Computer system 1000 may further include a communication or network interface 1024. Communication interface 1024 enables computer system 1000 to communicate and interact with any combination of remote devices, remote networks, remote entities, etc. (individually and collectively referenced by reference number 1028). For example, communication interface 1024 may allow computer system 1000 to communicate with remote devices 1028 over communications path 1026, which may be wired and/or wireless, and which may include any combination of LANs, WANs, the Internet, etc. Control logic and/or data may be transmitted to and from computer system 1000 via communication path 1026.

Image capture device(s) 1030 may include one or more camera units configured to capture images, e.g., images which may be processed to generate enhanced versions of the captured images, e.g., based on this disclosure. Image capture device(s) 1030 may include one or more lens assemblies 1034, where each lens assembly has a separate focal length. For example, one lens assembly may have a shorter focal length relative to the focal length of another lens assembly. Each of lens assembly(ies) 1034 may have a separate associated sensor element (e.g., sensor element(s) 1032). Alternatively, lens assembly(ies) 1034 may share common sensor element(s) 1032. Sensor element(s) 1032 may include image sensor(s) configured to convert light waves into electrical signals representing an image. Image capture device(s) 1030 may capture still and/or video images. Output from image capture device(s) 1030 may be processed, at least in part, by processor 1004 and/or a dedicated image processing unit or image signal processor 1036 incorporated within image capture device(s) 1030. Image signal processor 1036 may be configured to process captured images based on any suitable image processing algorithm. For example, image signal processor 1036 can process raw data that represents the captured images into a suitable file format, such as Y′UV, YUV, YCbCr, YPbPr, or any other file format. As another example, image signal processor 1036 may perform automatic white balance (AWB) and may resize images as needed. As an option, image signal processor 1036 may be configured to compress the images into a suitable format by employing any available compression standard, such as JPEG or MPEG and their associated variants. Local tone curve resampler 318 may be implemented via image signal processor 1036 and/or processor 1004. Captured images may be stored in main memory 1008 and/or secondary memory 1010.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 1000, main memory 1008, secondary memory 1010 and removable storage units 1018 and 1022, as well as tangible articles of manufacture embodying any combination of the foregoing. Such control logic, when executed by one or more data processing devices (e.g., computer system 1000), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 10. In particular, aspects may operate with software, hardware, and/or operating system implementations other than those described herein.

It is to be appreciated that the Detailed Description section, and not the Abstract of the Disclosure section, is intended to be used to interpret the claims. The Abstract of the Disclosure section may set forth one or more but not all possible aspects of the present disclosure as contemplated by the inventor(s), and thus, are not intended to limit the subjoined claims in any way.

Unless stated otherwise, the specific aspects are not intended to limit the scope of claims that are drafted based on this disclosure to the disclosed forms, even where only a single example is described with respect to a particular feature. The disclosed aspects are thus intended to be illustrative rather than restrictive, absent any statements to the contrary. The application is intended to cover such alternatives, modifications, and equivalents that would be apparent to a person skilled in the art having the benefit of this disclosure.

The foregoing disclosure outlines features of several aspects so that those skilled in the art may better understand the aspects of the present disclosure. Those skilled in the art will appreciate that they may readily use the present disclosure as a basis for designing or modifying other processes and structures for carrying out the same purposes and/or achieving the same advantages of the aspects introduced herein. Those skilled in the art will also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
determining a change between a first exposure time of a first frame captured by an image sensor and a second exposure time of a second frame captured by the image sensor subsequent to the first frame;
sampling a local tone curve generated for the first frame based on the change;
applying the sampled local tone curve to the second frame to generate an exposure-adjusted second frame; and
displaying the exposure-adjusted second frame.

2. The method of claim 1, wherein sampling the local tone curve generated for the first frame based on the change comprises:
sampling the local tone curve to match the second exposure time based on determining that the second exposure time is longer than the first exposure time, wherein to match the second exposure time, a first input range of brightness values for the sampled local tone curve is increased based on the second exposure time; and
clipping the sampled local tone curve at a clipping point to generate a clipped local tone curve.

3. The method of claim 2, wherein the clipping point corresponds to a first maximum input brightness value of a second input range of brightness values of the local tone curve generated for the first frame.

4. The method of claim 3, wherein the clipped local tone curve comprises a first output brightness value mapped to a first maximum input brightness value and the local tone curve generated for the first frame comprises a second input brightness value, and wherein the method further comprises:
increasing the first output brightness value to equal the second output brightness value.

5. The method of claim 1, wherein sampling the local tone curve generated for the first frame based on the change comprises:
sampling the local tone curve to match the second exposure time based on determining that the second exposure time is shorter than the first exposure time, wherein to match the second exposure time, a first input range of brightness values for the sampled local tone curve is decreased based on the second exposure time, and wherein the sampled local tone curve comprises a maximum output brightness value mapped to a maximum input brightness value of the first input range of brightness values; and
extending the first input range of brightness values for the sampled local tone curve beyond the maximum input brightness value.

6. The method of claim 5, further comprising:
mapping the maximum output brightness value to each input brightness value of the first input range of brightness values extended beyond the maximum input brightness value.

7. The method of claim 1, wherein the first exposure time is determined based on at least one of:
a first shutter time utilized when the first frame is captured by the image sensor;
a first automatic gain control setting utilized when the first frame is captured by the image sensor;
a first digital gain setting utilized when the first frame is captured by the image sensor; or
a first gain down ratio utilized when the first frame is captured by the image sensor; and
wherein the second exposure time is determined based on at least one of:
a second shutter time utilized when the second frame is captured by the image sensor;
a second automatic gain control setting utilized when the second frame is captured by the image sensor;
a second digital gain setting utilized when the second frame is captured by the image sensor; or
a second gain down ratio utilized when the second frame is captured by the image sensor.

8. A system, comprising:
a memory; and
at least one processor configured to:
determine a change between a first exposure time of a first frame captured by an image sensor and a second exposure time of a second frame captured by the image sensor subsequent to the first frame;
sample a local tone curve generated for the first frame based on the change;
apply the sampled local tone curve to the second frame to generate an exposure-adjusted second frame; and
display the exposure-adjusted second frame.

9. The system of claim 8, wherein, to sample the local tone curve generated for the first frame based on the change, the at least one processor is configured to:
sample the local tone curve to match the second exposure time based on determining that the second exposure time is longer than the first exposure time, wherein to match the second exposure time, a first input range of brightness values for the sampled local tone curve is increased based on the second exposure time; and
clip the sampled local tone curve at a clipping point to generate a clipped local tone curve.

10. The system of claim 9, wherein the clipping point corresponds to a first maximum input brightness value of a second input range of brightness values of the local tone curve generated for the first frame.

11. The system of claim 10, wherein the clipped local tone curve comprises a first output brightness value mapped to a first maximum input brightness value and the local tone curve generated for the first frame comprises a second input brightness value, and wherein the at least one processor is further configured to:
increase the first output brightness value to equal the second output brightness value.

12. The system of claim 8, wherein, to sample the local tone curve generated for the first frame based on the change, the at least one processor is configured to:
sample the local tone curve to match the second exposure time based on determining that the second exposure time is shorter than the first exposure time, wherein to match the second exposure time, a first input range of brightness values for the sampled local tone curve is decreased based on the second exposure time, and wherein the sampled local tone curve comprises a maximum output brightness value mapped to a maximum input brightness value of the first input range of brightness values; and
extend the first input range of brightness values for the sampled local tone curve beyond the maximum input brightness value.

13. The system of claim 12, wherein the at least one processor is configured to:
map the maximum output brightness value to each input brightness value of the first input range of brightness values extended beyond the maximum input brightness value.

14. The system of claim 8, wherein the first exposure time is determined based on at least one of:
a first shutter time utilized when the first frame is captured by the image sensor;
a first automatic gain control setting utilized when the first frame is captured by the image sensor;
a first digital gain setting utilized when the first frame is captured by the image sensor; or
a first gain down ratio utilized when the first frame is captured by the image sensor; and
wherein the second exposure time is determined based on at least one of:
a second shutter time utilized when the second frame is captured by the image sensor;
a second automatic gain control setting utilized when the second frame is captured by the image sensor;
a second digital gain setting utilized when the second frame is captured by the image sensor; or
a second gain down ratio utilized when the second frame is captured by the image sensor.

15. A non-transitory computer readable medium having instructions stored thereon that, when executed by at least one processor, cause the at least one processor to perform operations comprising:
determining a change between a first exposure time of a first frame captured by an image sensor and a second exposure time of a second frame captured by the image sensor subsequent to the first frame;
sampling a local tone curve generated for the first frame based on the change;
applying the sampled local tone curve to the second frame to generate an exposure-adjusted second frame; and
displaying the exposure-adjusted second frame.

16. The non-transitory computer readable medium of claim 15, wherein sampling the local tone curve generated for the first frame based on the change comprises:
sampling the local tone curve to match the second exposure time based on determining that the second exposure time is longer than the first exposure time, wherein to match the second exposure time, a first input range of brightness values for the sampled local tone curve is increased based on the second exposure time; and
clipping the sampled local tone curve at a clipping point to generate a clipped local tone curve.

17. The non-transitory computer readable medium of claim 16, wherein the clipping point corresponds to a first maximum input brightness value of a second input range of brightness values of the local tone curve generated for the first frame.

18. The non-transitory computer readable medium of claim 17, wherein the clipped local tone curve comprises a first output brightness value mapped to a first maximum input brightness value and the local tone curve generated for the first frame comprises a second input brightness value, and wherein the operations further comprise:
increasing the first output brightness value to equal the second output brightness value.

19. The non-transitory computer readable medium of claim 15, wherein sampling the local tone curve generated for the first frame based on the change comprises:
sampling the local tone curve to match the second exposure time based on determining that the second exposure time is shorter than the first exposure time, wherein to match the second exposure time, a first input range of brightness values for the sampled local tone curve is decreased based on the second exposure time, and wherein the sampled local tone curve comprises a maximum output brightness value mapped to a maximum input brightness value of the first input range of brightness values; and
extending the first input range of brightness values for the sampled local tone curve beyond the maximum input brightness value.

20. The non-transitory computer readable medium of claim 19, wherein the operations further comprise:
mapping the maximum output brightness value to each input brightness value of the first input range of brightness values extended beyond the maximum input brightness value.
